(19) United States
(12) Patent Application Publication
(10) Pub. No.: US 2016/0169088 A1
(43) Pub. Date: Jun. 16, 2016

(54) ENGINE SYSTEM WITH INTAKE GAS INDIVIDUALLY COOLED PER CYLINDER

(71) Applicant: Hyundai Motor Company, Seoul (KR)

(72) Inventor: Won Rok Choi, Seoul (KR)

(73) Assignee: Hyundai Motor Company, Seoul (KR)

(21) Appl. No.: 14/727,683

(22) Filed: Jun. 1, 2015

(30) Foreign Application Priority Data
Dec. 10, 2014 (KR) 10-2014-0177804

(51) Int. Cl. F02B 29/04; F02M 26/28; F02M 26/24; F02M 35/10

(52) U.S. Cl. CPC F02B 29/0437; F02M 35/10072; F02M 35/10222; F02M 26/28; F02M 26/24; F02B 29/0412

(57) ABSTRACT

An engine system with intake gas individually cooled per cylinder may include a cylinder head on a top of an engine configured to form combustion chambers together with a plurality of cylinders; an intake manifold having a plurality of runners configured to be connected to a plurality of intake ports formed in the cylinder head to be in fluidic communication with the plurality of engine cylinders through the plurality of intake ports and the plurality of runners; and a plurality of water cooling intercoolers for cooling at least one of exhaust gas recirculation (EGR) gas and new air with cooling water, wherein the plurality of water cooling intercoolers are connected to the plurality of runners, respectively.

### CROSS-REFERENCE TO RELATED APPLICATION

The present application claims priority to and the benefit of Korean Patent Application No. 10-2014-0177804 filed on Dec. 10, 2014, the entire contents of which is incorporated herein for all purposes by this reference.

### BACKGROUND OF THE INVENTION

1. Field of the Invention

The present invention relates to an engine system. More particularly, the present invention relates to an individual cylinder intake gas cooling system in an engine for making uniform individual cylinder intake gas cooling in an engine.

2. Description of Related Art

In general, a diesel engine is additionally provided with a supercharger and an intercooler for obtaining greater output from the engine.

The diesel engine having the supercharger applied thereto thus has exhaust gas or external air compressed with a compressor of the supercharger for supplying the exhaust gas or new air thusly compressed to the engine.

However, the new compressed air rapidly absorbs heat from the supercharger and heat generated in a process of the compression to have low density, resulting in poor charging efficiency.

Therefore, by cooling the new air, i.e., supercharged air, with the intercooler, high density supercharged air can be obtained, and, as a result of this, more air can be drawn into the engine cylinder, enabling greater output.

In addition, the diesel engine is provided with an exhaust gas recirculation (EGR) system mounted thereto for reducing exhaust of nitrogen oxides (NOx) which are air pollution materials.

Since the nitrogen oxides are noxious gas produced as oxygen and nitrogen are coupled at a high pressure and a high temperature, in order to suppress this, an exhaust gas recirculation (hereinafter, EGR) system supplies a portion of the exhaust gas being exhausted to the atmosphere to an intake system for dropping a highest combustion temperature and reducing oxygen supply for reducing the production of the nitrogen oxide.

Since the EGR system is required to recirculate the high temperature exhaust gas, the EGR system may be provided with an EGR cooler for cooling the exhaust gas. Of EGR coolers, there are a high pressure EGR cooler (HP-EGR cooler) connected to an exhaust manifold side EGR valve for cooling high pressure EGR gas directly flowing toward an intake manifold side, and a low pressure EGR cooler (LP-EGR cooler) for cooling low pressure EGR gas of which pressure is dropped as the exhaust gas passes through a turbine of the supercharger and a catalytic converter in succession.

Recently, a water cooling type of intercooler of which an intake route is reduced for improving cooling efficiency and responsiveness has been applied to the EGR system. In this case, since the intake manifold is constructed as one unit with the water cooling type of intercooler as a box type having no surge tank and runner, it is possible for flows among the cylinders to not be uniform.

Moreover, since the water cooling type of intercooler has a very small space for mixing the EGR gases and the new air, requiring a very short mixing time, EGR distribution is not favorable. In this case, the EGR distribution is a characteristic in which the high pressure EGR gas, the low pressure EGR, and the new air may be uniformly supplied to each of the cylinders of the engine while being appropriately mixed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an individual cylinder intake gas cooling system in an engine having advantages of improvement of fuel consumption, EGR distribution, and intake efficiency.

Various aspects of the present invention are directed to providing an individual cylinder intake gas cooling system in an engine, in which intake gas for cylinders in an engine is cooled uniformly for improving fuel consumption, EGR distribution, and intake efficiency.

In an aspect of the present invention, an engine system with intake gas individually cooled per cylinder may include a cylinder head on a top of an engine configured to form combustion chambers together with a plurality of cylinders, an intake manifold having a plurality of runners configured to be connected to a plurality of intake ports formed in the cylinder head to be in fluidic communication with the plurality of engine cylinders through the plurality of intake ports and the plurality of runners, and a plurality of water cooling intercoolers for cooling at least one of exhaust gas recirculation (EGR) gas and new air with cooling water, wherein the plurality of water cooling intercoolers are connected to the plurality of runners, respectively.

The system may further include an intercooler flange formed to connect the plurality of water cooling intercoolers to the cylinder head, wherein the plurality of water cooling intercoolers are mounted between the intercooler flange and the plurality of runners, respectively.

The system may further include an air control valve for controlling a flow rate of at least one of the EGR gas and the new air, wherein the air control valve is mounted to an inlet to the intake manifold for opening/closing the plurality of runners, in succession.

The air control valve may include a rotation shaft for controlling the flow rate of at least one of the EGR gas and the new air by controlling a rotation angle of the rotation shaft.

In another aspect of the present invention, an engine system with intake gas individually cooled per cylinder, may include a cylinder head on a top of an engine configured to form combustion chambers together with a plurality of cylinders, an intake manifold connected to a plurality of intake ports formed in the cylinder head to have a plurality of outlets to be in fluidic communication with the plurality of engine cylinders, and a plurality of water cooling intercoolers for cooling at least one of exhaust gas recirculation (EGR) gas and new air with cooling water, wherein the plurality of water cooling intercoolers are connected to the plurality of outlets, respectively, and wherein each of the plurality of water cooling intercoolers may have a cross section with a flow direction length larger than a width direction length for functioning as a runner of the intake manifold.

The system may further include an empty space of a predetermined volume formed at a portion of the intake manifold where the plurality of outlets branch therefrom, for moderating intake gas interference.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a schematic view of an engine system with intake gas individually cooled per cylinder in accordance with a first preferred embodiment of the present invention.

FIG. 2 illustrates a schematic view of an engine system with intake gas individually cooled per cylinder in accordance with a second preferred embodiment of the present invention.

FIG. 3 illustrates a schematic view of an engine system with intake gas individually cooled per cylinder in accordance with a third preferred embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereafter, exemplary embodiments of the present invention will be described with reference to the accompanying drawings such that persons skilled in this field of art can easily carry out the present invention.

Because the exemplary embodiment, being an exemplary embodiment of the present invention, may be embodied in different modes by persons skilled in this field of art, the scope of the present invention is not limited to the exemplary embodiments described hereafter.

Throughout the specification, unless explicitly described to the contrary, the word e embodied in different modes by persons skilled in this field of art, the scope of the present invention is not limited to the exemplary embodiments described hereafter. Moreover, a name of an element does not limit a function of the element.

Hereafter, exhaust gas recirculation will be indicated by to the contrary, the word e embodied in different modes by persons skilled in this field of art, the scope of the present invest gas recirculated thusly will be represented as EGR gas which may be divided into high pressure EGR gas and low pressure EGR gas depending on a pressure thereof

Though the individual cylinder intake gas cooling system in an engine in accordance with embodiments of the present invention may have an EGR system together with a supercharging system, the individual cylinder intake gas cooling system in an engine in accordance with embodiments of the present invention may employ only the supercharging system while excluding the EGR system.

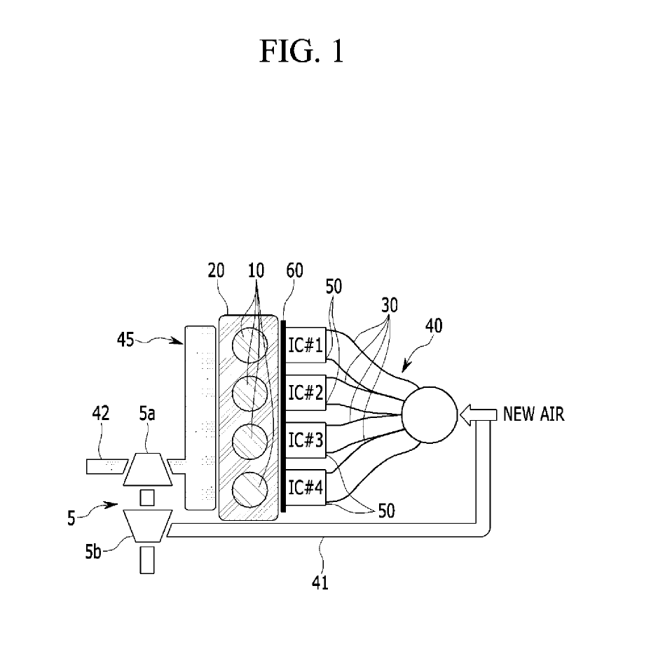

FIG. 1 illustrates a schematic view of an individual cylinder intake gas cooling system in an engine in accordance with a first exemplary embodiment of the present invention.

Referring to FIG. 1, the individual cylinder intake gas cooling system in an engine may include a cylinder head 20 on a top of the engine to form combustion chambers together with a plurality of cylinders 10, an intake manifold 40 having a plurality of runners 30 connected to a plurality of intake ports formed in the cylinder head 20 so as to be in fluidic communication with the plurality of engine cylinders 10 through the plurality of intake ports and the plurality of runners 30, and a plurality of water cooling type of intercoolers 50 for cooling at least one of EGR gas and new air with cooling water.

If the individual cylinder intake gas cooling system in an engine has the EGR system provided together with the supercharging system in accordance with an exemplary embodiment of the present invention, mixed gas of the EGR gas and the new air for each of the cylinders is cooled by one of the plurality of water cooling type of intercoolers 50, individually. If only the supercharging system is employed, which has no recirculation of the exhaust gas provided thereto, only the new air for each of the cylinders may be cooled, individually.

Since the plurality of intake ports are passages formed in the cylinder head 20 so as to be in communication with the plurality of engine cylinders 10, and structures are apparent to persons skilled in this field of art, detailed description and drawing thereof will be omitted.

The plurality of water cooling type of intercoolers 50 are respectively connected to the plurality of runners 30 such that the water cooling type of intercoolers 50 are mounted to be matched to the plurality of engine cylinders 10, independently.

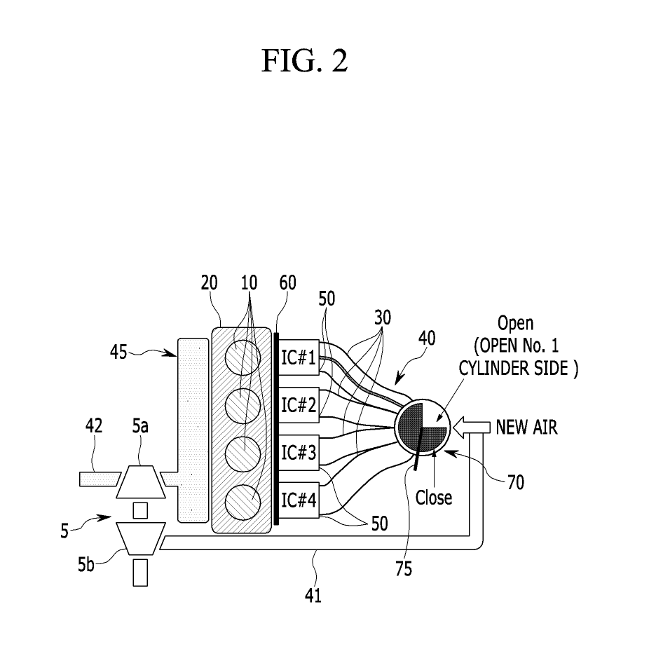

In this case, the cooled new air may be uniformly supplied to each of the plurality of engine cylinders. According to the preferred embodiment, the gas supplied to the plurality of engine cylinders 10 is not limited to the new air. The new air and the low pressure EGR gas may be cooled at each of the water cooling type of intercoolers 10 and uniformly supplied to respective engine cylinders. FIG. 2 illustrates a case when only the new air compressed by a compressor 5b of the supercharger 5 is supplied.

Along with this, since the plurality of runners 30 of the intake manifold 40 form adequately long flow passages, flow uniformity is improved.

Referring to FIG. 1, the individual cylinder intake gas cooling system in an engine in accordance with the exemplary embodiment may further include an intercooler flange 60 formed to connect the plurality of water cooling type of intercoolers 50 to the cylinder head 20. In this case, the plurality of water cooling type of intercoolers 50 are mounted between the intercooler flange 60 and the plurality of runners 30, respectively.

FIG. 2 illustrates a schematic view of an individual cylinder intake gas cooling system in an engine in accordance with a second exemplary embodiment of the present invention.

Referring to FIG. 2, the individual cylinder intake gas cooling system in an engine in accordance with the second exemplary embodiment of the present invention may further include an air control valve 70 for controlling a flow rate of at least one of the EGR gas and the new air to the individual cylinder intake gas cooling system in an engine in accordance with the first exemplary embodiment of the present invention. In this case, the individual cylinder intake gas cooling system in an engine has the water cooling type of intercoolers 50 mounted to the plurality of engine cylinders 10, respectively, the intake manifold 40 having the plurality of runners 30 formed thereon is applied to the individual cylinder intake gas cooling system, and the air control vale 70 is mounted to an inlet to the intake manifold 40.

In the second exemplary embodiment of FIG. 2, the plurality of water cooling type of intercoolers 50 may be mounted to the cylinder head 20 with the intercooler flange 60.

The air control valve 70 is connected to the runners 40 at the intake manifold 40, and may be controlled to open 1/N only in a new air intake process of the engine cylinder 10. That is, the air control valve 70 is mounted to the inlet of the intake manifold 40 for sequentially opening/closing the plurality (N) of runners 30.

In this case, the air control valve 70 has a rotation shaft 75 mounted thereto for use in controlling an individual intake process. That is, the air control valve 70 includes the rotation shaft 75 for controlling the flow rate of at least one of the EGR gas and the new air by controlling a rotation angle of the rotation shaft 75.

With this, intake gas interference in the individual cylinder intake gas cooling system in an engine in accordance with the second exemplary embodiment of the present invention is suppressed. That is, intake of the new air or the mixed gas of the new air and the low pressure EGR gas to the cylinders which are not in an explosion stroke states is prevented. Consequently, intake efficiency may be improved.

In order to suppress the intake gas interference which makes the intake efficiency poor, there are cases when a surge tank is mounted to the intake manifold. However, the second exemplary embodiment of the present invention may permit elimination of the surge tank.

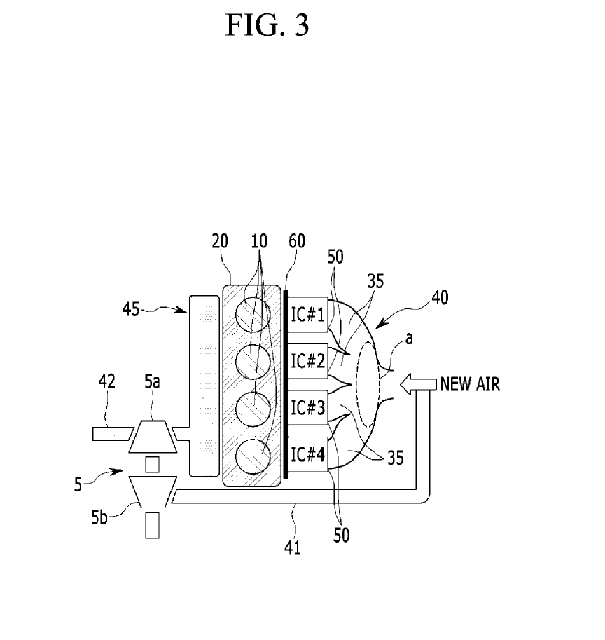

FIG. 3 illustrates a schematic view of an individual cylinder intake gas cooling system in an engine in accordance with a third exemplary embodiment of the present invention.

Referring to FIG. 3, the individual cylinder intake gas cooling system in an engine in accordance with the third exemplary embodiment of the present invention may include a cylinder head 20 on a top of the engine to form combustion chambers together with a plurality of cylinders 10, an intake manifold 40 connected to a plurality of intake ports formed in the cylinder head 20 to have a plurality of outlets 35 so as to be in fluidic communication with the plurality of engine cylinders 10, and a plurality of water cooling type of intercoolers 50 for cooling at least one of EGR gas and new air with cooling water.

The plurality of water cooling type of intercoolers 50 are connected to the plurality of outlets 35, respectively, wherein each the plurality of water cooling type of intercoolers 50 may have a cross-section with a larger flow direction length than a width direction length for functioning as a runner of the intake manifold 40.

Accordingly, the individual cylinder intake gas cooling system in an engine in accordance with the third exemplary embodiment of the present invention may employ an intake manifold having no runners, such that the plurality of water cooling type of intercoolers 50 perform a function of the plurality of runners 30 in FIGS. 1 and 2.

With this, a flow of the mixed gas or the new air becomes uniform, and the EGR distribution may be improved.

Along with this, referring to FIG. 3, at a portion of the intake manifold 40 where the plurality of outlets 35 branch therefrom, an empty space of a specific volume may be formed for moderating the intake gas interference. A dashed line a in FIG. 3 denotes the empty space. The empty space formed thusly moderates the intake gas interference and improves the intake efficiency. That is, an inlet portion to the intake manifold 40 may function as a surge tank by using the empty space.

Therefore, the individual cylinder intake gas cooling system in an engine in accordance with the third exemplary embodiment of the present invention improves fuel consumption, the EGR distribution, and the intake efficiency owing to individual uniform cooling of the new air to the engine cylinders. Along with this, elimination of a separate surge tank may save cost.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine system with intake gas individually cooled per cylinder, comprising:
a cylinder head on a top of an engine configured to form combustion chambers together with a plurality of cylinders;
an intake manifold having a plurality of runners configured to be connected to a plurality of intake ports formed in the cylinder head to be in fluidic communication with the plurality of engine cylinders through the plurality of intake ports and the plurality of runners; and
a plurality of water cooling intercoolers for cooling at least one of exhaust gas recirculation (EGR) gas and new air with cooling water,
wherein the plurality of water cooling intercoolers are connected to the plurality of runners, respectively.

2. The system of claim 1, further comprising an intercooler flange formed to connect the plurality of water cooling intercoolers to the cylinder head,
wherein the plurality of water cooling intercoolers are mounted between the intercooler flange and the plurality of runners, respectively.

3. The system of claim 1, further comprising an air control valve for controlling a flow rate of at least one of the EGR gas and the new air.

4. The system of claim 3, wherein the air control valve is mounted to an inlet to the intake manifold for opening/closing the plurality of runners, in succession.

5. The system of claim 4, wherein the air control valve includes a rotation shaft for controlling the flow rate of at least one of the EGR gas and the new air by controlling a rotation angle of the rotation shaft.

6. An engine system with intake gas individually cooled per cylinder, comprising:
a cylinder head on a top of an engine configured to form combustion chambers together with a plurality of cylinders;
an intake manifold connected to a plurality of intake ports formed in the cylinder head to have a plurality of outlets to be in fluidic communication with the plurality of engine cylinders; and
a plurality of water cooling intercoolers for cooling at least one of exhaust gas recirculation (EGR) gas and new air with cooling water,
wherein the plurality of water cooling intercoolers are connected to the plurality of outlets, respectively, and
wherein each of the plurality of water cooling intercoolers has a cross section with a flow direction length larger than a width direction length for functioning as a runner of the intake manifold.

7. The system of claim 6, further comprising an empty space of a predetermined volume formed at a portion of the intake manifold where the plurality of outlets branch therefrom, for moderating intake gas interference.
